(19) United States
(12) Patent Application Publication
(10) Pub. No.: US 2026/0061752 A1
(43) Pub. Date: Mar. 5, 2026

(54) PRINTING APPARATUS

(71) Applicant: SEIKO EPSON CORPORATION, Tokyo (JP)

(72) Inventor: Osamu MURAYAMA, YAMAGATA-MURA (JP)

(21) Appl. No.: 19/316,182

(22) Filed: Sep. 2, 2025

(30) Foreign Application Priority Data
Sep. 5, 2024 (JP) 2024-153016

(51) Int. Cl. B41J 2/175; B41J 2/17; B41J 2/21; B41J 11/02

(52) U.S. Cl. CPC B41J 2/17523; B41J 2/1707; B41J 2/17596; B41J 2/2103; B41J 2/2117; B41J 11/02

(57) ABSTRACT

A printing apparatus includes a medium support unit for supporting a medium, a head for ejecting a first liquid and a second liquid to the medium supported by the medium support unit, a first liquid supply unit that supplies the first liquid and a second liquid supply unit that supplies the second liquid to the head, and an operation panel for performing an operation related to at least the first liquid supply unit, wherein the first liquid supply unit and the second liquid supply unit are disposed side by side below the medium support unit, and the first liquid supply unit is disposed at a position closer to the operation panel than the second liquid supply unit.

The present application is based on, and claims priority from JP Application Serial Number 2024-153016, filed September 5, 2024, the disclosure of which is hereby incorporated by reference herein in its entirety.

### BACKGROUND

### Technical Field

The present disclosure relates to a printing apparatus.

### Related Art

In the past, there has been known a printing apparatus that performs printing on a large medium. For example, JP-A-2023-7789 discloses, as the printing apparatus for a large-sized medium, a recording apparatus including holding units of liquid containers at two places at left and right sides of the front thereof.

JP-A-2023-7789 is an example of the related art.

However, in the apparatus described in JP-A-2023-7789, there is a problem that it is difficult to improve the workability of maintenance related to the liquid containers. Specifically, although not explicitly described in that apparatus, many printing apparatuses for a large-sized medium include an operation panel. In such printing apparatuses for a large-sized medium, in general, the operation panel is disposed closer to one of the left and right sides of the front of an apparatus housing.

In addition, in the printing apparatus for a large-sized medium, special color ink such as white ink may be used in addition to ink of normal colors such as cyan, magenta, yellow, and black in some cases. Therefore, in a configuration in which the operation panel is disposed on either one of the left and right sides of the front of the apparatus and the liquid container for the special color ink is mounted on the other of the left and right sides of the front of the apparatus, the operation panel and the liquid container for the special color ink are disposed at a distance from each other. Some special color ink requires periodic maintenance such as stirring, and in the arrangement described above, it becomes difficult to perform work such as inserting and removing the liquid container of the special color ink while operating the operation panel. That is, there has been a demand for an apparatus that improves the workability of the maintenance of the liquid container accompanying the operation of the operation panel.

### SUMMARY

A printing apparatus includes a platen configured to support a medium, a head configured to eject a first liquid and a second liquid onto the medium supported by the platen, a first liquid supply unit configured to supply the first liquid to the head, a second liquid supply unit configured to supply the second liquid to the head, and an operation panel configured to perform an operation related to at least the first liquid supply unit, wherein the first liquid supply unit and the second liquid supply unit are arranged side by side below the platen, and the first liquid supply unit is disposed at a position closer to the operation panel than the second liquid supply unit.

### BRIEF DESCRIPTION OF THE DRAWINGS

FIG. 1 is a schematic cross-sectional view illustrating a configuration of a printing apparatus according to an embodiment.

FIG. 2 is a schematic front view showing an arrangement of a first liquid supply unit, a second liquid supply unit, and so on.

### DESCRIPTION OF EMBODIMENTS

In an embodiment described below, an inkjet printer for a large-sized medium will be described as an example of a printing apparatus with reference to the drawings. The printing apparatus according to the present disclosure is not limited to the following configuration.

In each of the following drawings, X, Y, and Z axes that are coordinate axes orthogonal to each other are given, a direction indicated by each arrow is defined as a positive (+) direction, and a direction opposite to the positive direction is defined as a negative (-) direction. In the present embodiment, a state in which the printing apparatus is installed on a horizontal surface such as a floor will be described, and the +Z direction is also referred to as above and the -Z direction is also referred to as below. In the above state, the -Z direction coincides with a vertical direction. Further, in each of the following drawings, the size of each member is made different from the actual size for the sake of convenience of illustration.

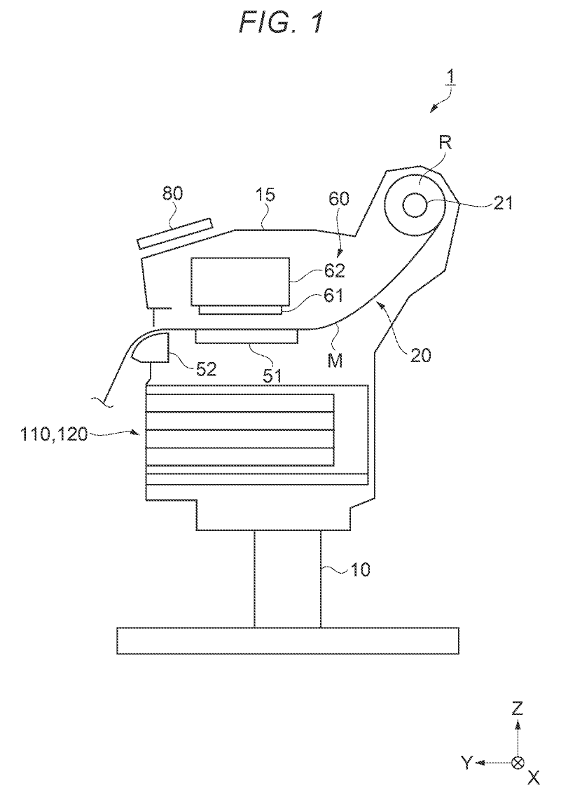

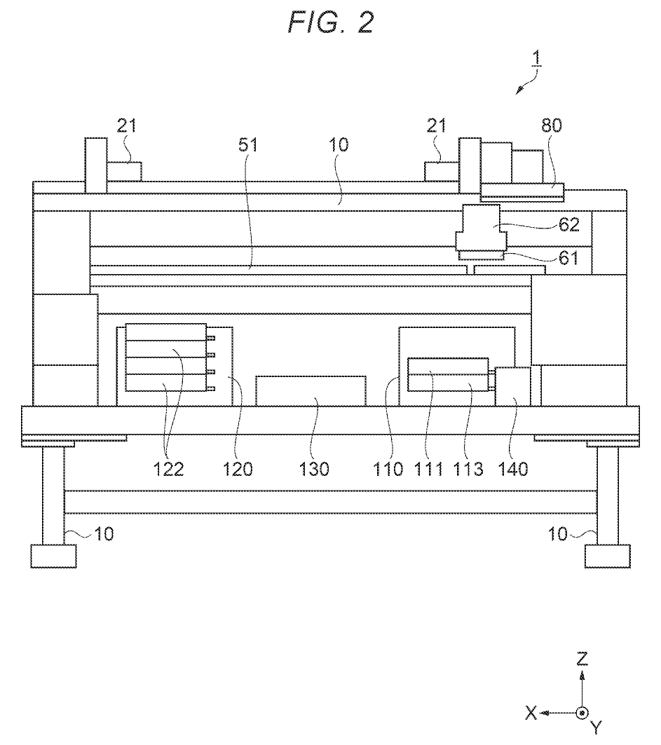

In the following description, FIG. 1 illustrates a state viewed from the -X direction, and FIG. 2 illustrates a state viewed from the front side which is the +Y direction unless otherwise specified.

As illustrated in FIG. 1, a printing apparatus 1 according to the present embodiment includes a structural member 10, a housing 15, a conveyance unit 20, a medium support unit 51, a printing unit 60, an operation panel 80, a first liquid supply unit 110, and a second liquid supply unit 120. The housing 15 is an exterior member of the printing apparatus 1 and houses the configuration described above inside. The printing apparatus 1 also includes a controller (not illustrated).

The printing apparatus 1 manufactures a printed matter by attaching a liquid such as ink to a medium M which is a sheet shaped like a continuous form. In the printing apparatus 1, the medium M is fed from a roll body R as an original roll to be subjected to printing, and is then discharged from the printing apparatus 1.

In the printing apparatus 1, the +Y direction side corresponds to the front. A user of the printing apparatus 1 performs principal operations and work at the +Y direction side, which is the front side, of the printing apparatus 1. In the following description, the user of the printing apparatus 1 is also simply referred to as a user.

A movement path of the medium M through which the medium M is fed out from the roll body R and is then discharged is defined as a conveyance path. In the conveyance path, the roll body R side of the medium M is also referred to as upstream, and the side to which the medium M proceeds is also referred to as downstream. On the conveyance path, the roll body R, the medium support unit 51, the printing unit 60, and a medium support unit 52 are disposed in this order from upstream to downstream. In the conveyance path, a direction in which the medium M moves from upstream to downstream is also referred to as a conveyance direction.

The controller is electrically coupled to each of the elements described above of the printing apparatus 1 to integrally control operations of the elements. The controller includes hardware such as a central processing unit (CPU), a read only memory (ROM), and a random access memory (RAM). The controller controls the printing apparatus 1 by the CPU executing a predetermined control program. The ROM is a non-volatile storage device and stores the control program to be executed by the CPU and data processed in the control program. The RAM configures a work area of the CPU. The CPU loads the control program read from the ROM or the like into the RAM and executes the control program thus loaded to control the printing apparatus 1.

The operation panel 80 is also electrically coupled to the controller. The user performs an operation related to at least the first liquid supply unit 110 via the operation panel 80. In addition to the above operations, the operation panel 80 displays various types of information related to the printing apparatus 1, and receives operational instructions other than the above operations related to start and stop of the operation, printing execution, maintenance, and so on. Details of the above operations will be described later.

The operation panel 80 is supported by the structural member 10 via a member (not illustrated), and is disposed above the housing 15 and in an end portion in the +Y direction. The user stands at the +Y direction side of the printing apparatus 1 and performs the various operations while viewing the operation panel 80. The operation panel 80 is, for example, a touch panel type liquid crystal display, and receives input of the various operations and various settings by the user in addition to display of various types of information. The operation panel 80 may include physical buttons in addition to the liquid crystal display.

The structural member 10 is a frame that supports the elements described above of the printing apparatus 1. The structural member 10 is formed by assembling a plurality of sheet metal members, tubular members, and so on. In the structural member 10, a caster, an installation member, or the like may be attached to a portion in contact with a floor at a lower side.

The conveyance unit 20 includes a roll body holder 21, the medium support unit 52, and a plurality of conveyance rollers (not illustrated). The roll body holder 21 rotatably supports the roll body R around a shaft along the X axis. The roll body holder 21 is disposed so as to protrude upward at the -Y direction side of the printing apparatus 1. The medium M is pulled by the conveyance roller to be fed downstream from the roll body R, and is supplied. The roll body R is detachably attached to the printing apparatus 1. The medium M is conveyed substantially downward from the roll body holder 21 and proceeds to the medium support unit 51.

The conveyance rollers may be disposed at various positions on the conveyance path to convey the medium M. Each of the conveyance rollers includes, for example, a drive roller rotationally driven by an electric motor and a driven roller driven by the drive roller. The drive roller and the driven roller each rotate about a shaft along the X axis. The medium M is conveyed while being pinched between the drive roller and the driven roller.

The medium M is appropriately selected in accordance with a type of the liquid such as the ink to be attached to the medium M, a purpose of the printed matter, and so on. Examples of the ink include aqueous ink, non-aqueous ink, and electron beam curable ink. As the medium M, a resin film, a resin sheet, coated paper, or the like is applied. A surface of the medium M facing upward is a printing surface, and is a surface on which printing is performed by attaching the ink.

The medium support unit 51 comes into contact with a lower surface as an opposite surface to the printing surface of the medium M to support the medium M. The medium support unit 51 is an example of a platen in the present disclosure. An upper surface of the medium support unit 51 extends along the X-Y plane. In the medium support unit 51, the conveyance direction of the medium M is the +Y direction. The first liquid supply unit 110 and the second liquid supply unit 120 are disposed below the medium support unit 51.

The medium support unit 51 may incorporate an electric heater that heats the medium M. The electric heater heats the medium M to improve fixability of the ink or the like to the medium M and promote volatilization of a volatile component such as water contained in the ink.

The printing unit 60 performs printing on the medium M. The printing unit 60 includes a head 61 and a carriage 62. The printing unit 60 is disposed above the medium support unit 51. The carriage 62 is supported by the structural member 10 described above so as to be able to reciprocate along the X axis. The carriage 62 reciprocates along the X axis by driving of a carriage motor (not illustrated). The carriage 62 supports the head 61 so as to be opposed to the medium support unit 51.

The head 61 ejects and attaches the liquid such as the ink to the printing surface of the medium M supported by the medium support unit 51. The liquid ejected by the head 61 includes a first liquid and a second liquid described later. The head 61 reciprocates, together with the carriage 62, along the X axis in a range including a region opposed to the medium support unit 51 in the vertical direction.

Although not illustrated, a nozzle surface is disposed on a surface facing downward of the head 61. A plurality of nozzle arrays is provided to the nozzle surface. Each of the nozzle arrays includes a plurality of nozzles that ejects the liquid such as the ink. The liquid is individually supplied from the first liquid supply unit 110 and the second liquid supply unit 120 to each of the nozzle arrays for each type of the liquid.

Specifically, the first liquid and a third liquid are supplied from the first liquid supply unit 110 to the head 61. The first liquid is so-called special color ink, and is white ink in the present embodiment. The third liquid is a liquid containing no color material, and is a cleaning liquid or a treatment liquid. The first liquid, the third liquid, and the second liquid described later are individually stored in cartridges that are storage containers.

In the white ink in the present embodiment, titanium oxide is applied as the color material. Titanium oxide is higher in specific gravity than pigments for so-called normal colors such as black, cyan, magenta, and yellow. In addition, the white ink tends to be relatively high in pigment concentration or relatively large in particle size for the purpose of improving the whiteness and ensuring a property of hiding the base. Therefore, settling of the titanium oxide contained in the white ink is more likely to progress than those of the pigments for the normal colors. When the settling progresses significantly, there is a concern that hard caking may occur. Note that in the present specification, the particle size refers to a 50% particle size (so-called D50).

In the present embodiment, a titanium oxide pigment having a particle size and a specific gravity larger than those of the second liquid is dispersed in the white ink as the first liquid. Therefore, in the white ink, the whiteness and the property of hiding the base are improved. On the other hand, in the first liquid, the pigment is more likely to settle compared to the second liquid, and maintenance at short intervals is required.

In contrast, in the printing apparatus 1 according to the present embodiment, it is recommended to perform an operation of demounting the cartridge of the white ink from the first liquid supply unit 110 and shaking the cartridge. In addition, a liquid circulation unit that circulates the white ink in a pipe by flowing the white ink in a state where the cartridge of the white ink is mounted on the first liquid supply unit 110 is also provided. Accordingly, in the printing apparatus 1, the settling in the white ink is suppressed, and the occurrence of a failure such as hard caking is prevented. Further, in the printing apparatus 1, since the workability of maintenance of the first liquid supply unit 110 is improved, it is possible to reduce the labor of the user. The liquid circulation unit and the workability described above will be described later in detail.

As the first liquid, ink containing a color material higher in specific gravity than organic pigments, such as metallic ink containing silver particles or aluminum fragments as a pigment, may be applied besides the white ink. Note that the first liquid is not limited to the special color ink, the cleaning liquid, and the treatment liquid. As the first liquid, a liquid that is assumed to be frequently subjected to work such as cartridge insertion and removal may be applied, among the ink applied to the printing apparatus 1.

The cleaning liquid is applied to cleaning of a member such as the head 61 which the ink or the like flows through or comes into contact with in the printing apparatus 1. The cleaning liquid is not required to be ejected onto the medium M from the head 61. The treatment liquid is applied to pre-processing in which the treatment liquid is applied to the medium M before the ink is attached and post-processing in which the treatment liquid is applied on the ink attached to the medium M.

The second liquid is supplied from the second liquid supply unit 120 to the head 61. The second liquid is ink which contains a color material and exhibits a color such as cyan, yellow, magenta, and black. Note that the second liquid may include special color ink such as red ink that does not require frequent stirring work which is required for the white ink.

The first liquid, the second liquid, and so on are supplied from the respective cartridges to the head 61 via pipes (not illustrated), and are ejected from the corresponding nozzle arrays toward the printing surface of the medium M.

In the head 61, piezoelectric elements are used as actuators as drivers. The drivers are not limited thereto. As the drivers, for example, electromechanical conversion elements that displace vibrating plates as the actuators with electrostatic adsorption, or electrothermal conversion elements that eject the ink as droplets using air bubbles generated by heating may be applied.

In addition, the head 61 is not limited to a serial type which reciprocates while being supported by the carriage 62. There may be adopted a configuration in which the head 61 is arranged in a line along the X axis and does not reciprocate along the X axis.

In the medium support unit 51, the head 61 is reciprocated along the X axis together with the carriage 62 while conveying the medium M in the +Y direction. On this occasion, an image such as a picture, a photograph, a text, or a pattern is printed on the medium M by attaching the first liquid or the second liquid to the printing surface of the medium M at appropriate timings. The medium M on which the printing has been performed is conveyed from the medium support unit 51 to the medium support unit 52.

The medium support unit 52 has a curved surface and makes contact with and supports the lower surface of the medium M conveyed. The medium M is conveyed while sliding in contact with the curved surface of the medium support unit 52. The conveyance direction of the medium M is changed from the +Y direction to a direction between the +Y direction and a slightly downward direction by the curved surface of the medium support unit 52.

The medium support unit 52 may incorporate an electric heater that heats the medium M. The electric heater heats droplets of the liquid such as the ink applied to the medium M to promote volatilization of the volatile component such as water contained in the droplets.

The medium M turned to the printed matter is discharged toward the +Y direction from the printing apparatus 1 via the medium support unit 52. In this way, the printed matter is manufactured. The printing apparatus 1 may include a medium cutter in the vicinity of the medium support unit 52 to cut the printed matter along the X axis. In addition, the printed matter may be cut along the X axis after being discharged from the printing apparatus 1, or may be conveyed to a post-processing apparatus or the like installed at the +Y direction side of the printing apparatus 1. Further, the printed matter may be subjected to secondary processing such as transfer processing.

As illustrated in FIG. 2, the operation panel 80 is disposed above at the -X direction side of the printing apparatus 1. The user views or operates the operation panel 80 at a position closer to the -X direction side in front of the printing apparatus 1. Here, in FIG. 2, the roll body R, the medium M, the housing 15, and so on are not illustrated.

In the printing apparatus 1, the medium support unit 51 is disposed over an area from the vicinity of an end portion in the +X direction to a position slightly set back toward the +X direction from an end portion in the -X direction. Although not illustrated, a suction mechanism of the head 61 and so on are disposed at the -X direction side of the medium support unit 51. Therefore, the carriage 62 and the head 61 can move further in the -X direction than the position shown in FIG. 2. The medium support unit 51 is located at the +X direction side of the operation panel 80 in the direction along the X axis. The end portion in the -X direction of the medium support unit 51 and the end portion in the +X direction of the operation panel 80 may be at positions overlapping in the direction along the X axis. At least a part of the operation panel 80 may be located at the +Y direction side of the medium support unit 52 in a direction along the Y axis.

The first liquid supply unit 110 and the second liquid supply unit 120 are located below the medium support unit 51 and are arranged side by side in the X direction. Specifically, the first liquid supply unit 110 is disposed to protrude toward the -X direction from the end portion in the -X direction of the medium support unit 51 in the direction along the X axis. In other words, in plan view from above, a part of the first liquid supply unit 110 is disposed at a position deviated toward the -X direction from the medium support unit 51. An end portion in the -X direction of the first liquid supply unit 110 and an end portion in the +X direction of the operation panel 80 are at positions overlapping each other in the direction along the X axis. An end portion in the +Y direction of the first liquid supply unit 110 and an end portion in the +Y direction of the second liquid supply unit 120 are located at the -Y direction side of an end portion in the +Y direction of the medium support unit 52.

The second liquid supply unit 120 is disposed at a position set back toward the -X direction from the end portion in the +X direction of the medium support unit 51 in the direction along the X axis. That is, the first liquid supply unit 110 is disposed at a position closer to the operation panel 80 than the second liquid supply unit 120.

Cartridges 111, 113 are mounted on the first liquid supply unit 110. The cartridges 111, 113 can be inserted into and removed from the first liquid supply unit 110. The cartridge 111 is filled with the white ink as the first liquid. The cartridge 113 is filled with the cleaning liquid or the treatment liquid as the third liquid. The number of the cartridges 111, 113 is not limited to one for each thereof.

Four cartridges 122 are mounted on the second liquid supply unit 120. The cartridges 122 can be inserted into and removed from the second liquid supply unit 120. The cartridges 122 are each filled with the ink as the second liquid. The number of the cartridges 122 is not limited to four. The cartridges 122 are less frequently inserted and removed compared to the cartridges 111, 113.

The cartridges 111, 113, and 122 each include an exterior housing made of hard resin, a container that is disposed in the exterior housing and is capable of storing a liquid inside, and a supply portion for supplying the liquid stored therein. The container includes, for example, a resin sheet provided with a metal thin film. In the container, the resin sheet is formed in a bag shape. The supply portion seals the container and supplies the liquid stored therein to a pipe connected to the head 61 when the supply portion is mounted on to the printing apparatus 1.

In order to suppress settling of the titanium oxide pigment inside, the cartridge 111 is recommended to be demounted from the first liquid supply unit 110 and periodically shaken. The cleaning liquid tends to be relatively large in amount used compared to the ink containing the color material. In addition, the treatment liquid may be attached to the medium M in a solid state in some cases, and the amount used is likely to relatively increase. Therefore, the cartridge 113 may need to be replaced relatively frequently in some cases.

For example, the user visually recognizes a shaking instruction of the cartridge 111 displayed on the operation panel 80, demounts the cartridge 111 from the first liquid supply unit 110 to shake the cartridge 111, and then mounts the cartridge 111 once again. On this occasion, the operation panel 80 is operated. For example, removal of the cartridge 111 is input to the operation panel 80, and completion of shaking operation or the like is also input. Assuming a configuration in which the cartridge 111 is mounted on the second liquid supply unit 120, the flow line of the series of operations is elongated, and the workability is likely to deteriorate. Assuming that the cartridge 113 is mounted on the second liquid supply unit 120, the workability tends to deteriorate similarly to the cartridge 111.

In the direction along the X axis, the width dimension of the medium M described above is shorter than the width dimension of the medium support unit 51. Even the medium M having the largest width is recommended to be, for example, about 85 mm shorter than the width dimension of the medium support unit 51. However, since the medium M is conveyed above the second liquid supply unit 120 during printing, it is difficult to perform work related to the second liquid supply unit 120 while visually observing or operating the operation panel 80.

In contrast, in the printing apparatus 1, a part of the upper side of the first liquid supply unit 110 is deviated from the end in the -X direction of the medium M. Therefore, it becomes possible for the user to perform work with an end in the -X direction of the medium M turned up. That is, even in a state where the printed matter is located in front of the medium support unit 51 during or immediately after printing in the printing apparatus 1, it becomes possible to perform work such as insertion and removal of the cartridges 111, 113, and it is possible to improve convenience of the user.

The printing apparatus 1 includes a liquid feeding unit 130. The liquid feeding unit 130 is a liquid feeding pump, and supplies the first liquid, the second liquid, and the third liquid from the first liquid supply unit 110 and the second liquid supply unit 120 to the head 61. The liquid feeding unit 130 is disposed below the medium support unit 51 and is arranged between the first liquid supply unit 110 and the second liquid supply unit 120.

The liquid feeding unit 130, the cartridges 111, 113 of the first liquid supply unit 110, and the cartridges 122 of the second liquid supply unit 120 are connected to each other with pipes (not shown). Further, the liquid feeding unit 130 and the head 61 are connected to each other with an individual pipe (not illustrated) for each type of the liquid such as the ink. A known liquid feeding pump can be applied to the liquid feeding unit 130.

A liquid circulation unit 140 is disposed in the vicinity of the first liquid supply unit 110 in the -X direction. The liquid circulation unit 140 is a circulation pump, and suppresses an occurrence of settling, clogging, and the like of the titanium oxide pigment by circulating the white ink in a path such as a pipe through which the white ink flows.

The liquid circulation unit 140 is interposed in the pipe from the cartridge 111 mounted on the first liquid supply unit 110 to the head 61 via the liquid feeding unit 130. When the liquid circulation unit 140 operates, the white ink in the pipe circulates. A known circulation pump can be applied to the liquid circulation unit 140.

The liquid circulation unit 140 is disposed at a position closer to the first liquid supply unit 110 than to the second liquid supply unit 120. Therefore, the pipe connecting the liquid circulation unit 140 and the first liquid supply unit 110 is shortened to make it possible to suppress the liquid feeding loss when circulating the white ink, and reduce the load on the operation of the liquid circulation unit 140.

According to the present embodiment, the following advantages can be obtained.

It is possible to improve the workability of the maintenance of the first liquid supply unit 110 accompanied by the operation of the operation panel 80. Specifically, since the first liquid supply unit 110 is located at a position close to the operation panel 80, the user of the printing apparatus 1 can easily perform the work related to the first liquid supply unit 110 while operating or viewing the operation panel 80. Therefore, it is possible to provide the printing apparatus 1 that improves the workability of the maintenance of the first liquid supply unit 110 accompanied by the operation of the operation panel 80.

What is claimed is:

1. A printing apparatus comprising:
a platen configured to support a medium; a head configured to eject a first liquid and a second liquid onto the medium supported by the platen;
a first liquid supply unit configured to supply the first liquid to the head; a second liquid supply unit configured to supply the second liquid to the head; and
an operation panel configured to perform an operation related to at least the first liquid supply unit, wherein the first liquid supply unit and the second liquid supply unit are arranged side by side below the platen, and the first liquid supply unit is disposed at a position closer to the operation panel than the second liquid supply unit.

2. The printing apparatus according to claim 1, further comprising a liquid circulation unit configured to circulate the first liquid, wherein the liquid circulation unit is disposed at a position closer to the first liquid supply unit than to the second liquid supply unit.

3. The printing apparatus according to claim 2, wherein a pigment larger in particle size and specific gravity than in the second liquid is dispersed in the first liquid.

4. The printing apparatus according to claim 1, wherein the first liquid supply unit supplies a third liquid containing no color material, and the second liquid contains the color material.

5. The printing apparatus according to claim 1, wherein a part of the first liquid supply unit is disposed at a position deviating from the platen in plan view.
